(19) United States
(12) Patent Application Publication
(10) Pub. No.: US 2018/0363763 A1
(43) Pub. Date: Dec. 20, 2018

(54) SYSTEMS AND METHODS FOR FLUID CIRCULATION AND DELIVERY IN CONTINUOUSLY VARIABLE TRANSMISSIONS

(71) Applicant: Fallbrook Intellectual Property Company LLC, Cedar Park, TX (US)

(72) Inventors: Brad P. Pohl, Leander, TX (US); Feng Wang, Austin, TX (US)

(21) Appl. No.: 16/101,221

(22) Filed: Aug. 10, 2018

(51) Int. Cl. F16H 57/04; F16H 15/50

(52) U.S. Cl. CPC F16H 57/0484; F16H 15/503; F16H 57/043; F16H 57/0428; F16H 57/0487; F16H 57/0421

(57) ABSTRACT

A lubrication system for fluid circulation and delivery to specific components in ball planetary continuously variable transmissions contained in spinning hubs. A tube has a first end extending radially outward into a fluid volume maintained by inertia caused by the spinning shell and a second end extends radially inward near a component. An orifice is positioned near an interior surface of the hub shell and an opening is positioned near the component, such as a sun bearing, planet axle, or other rotating component. As the shell rotates, fluid rotating with the shell enters the orifice and is forced along the tube to the opening, where it exits to lubricate the selected component or components. A circumferential groove in the hub shell collects fluid for controlling fluid flow into the tube, reducing the volume of fluid needed in the CVT.

### BACKGROUND

As emission limits place greater emphasis on optimizing drivetrain performance in vehicles, motorcycles and other lightweight vehicles are becoming more popular. Their popularity is due in part to small motors and engines generating more power with increased efficiency. Both internal combustion engines and electric motors are advancing in technology such that smaller engines and electric motors are capable of even greater power and efficiency, making these lightweight vehicles even more popular.

Most motorcycle drivetrains have an engine as a prime mover, but electric motors are also gaining popularity as manufacturers look to new power options.

In addition to an engine or motor, motorcycles generally include a gear box having a few gears, a clutch to switch between gears, and either a chain-sprocket system or belt-pulley system that transfers power from the engine to the rear wheel while providing a fixed gear ratio. Recently, manufacturers have started implemented belt driven continuously variable transmissions (CVTs) for possible improvements in the overall performance of the drivetrain.

In power generation systems such as internal combustion engines, torsional vibration is commonly generated relative to a shaft along its axis of rotation. Torsional vibration can cause failures if not controlled, and torsional vibration can lead to noticeable vibrations or noise at certain speeds, which are undesirable. A torsion damper (also referred to as a torsional damper, torsion dampener or torsional dampener) is included to reduce torsional vibration in a drivetrain.

An engine may operate optimally at a first speed (N1), but a pump, alternator, or other component may operate optimally at a lower speed (N2), and a wheel may rotate at a third speed (N3). A gear ratio (GR) between the prime mover and a component allows the prime mover to operate within a first speed range and the component to operate within a second speed range.

A transmission with multiple gears has multiple gear ratios and allows the engine or motor to operate within a first speed range and the vehicle to travel at a target speed. A gear ratio may be implemented by various systems, including two gears or pulleys with a chain, belt, or other endless member, or a gear set, such as a planetary gear set. Typically, motorcycles have a front gear (with a first radius and first tooth count) associated with an output of the engine coupled by a chain or belt to a rear gear (with a second radius and second tooth count) associated with the rear axle. The difference between the first radius and the second radius results in a speed reduction (and a corresponding torque increase).

As used herein, the term “transverse” or “longitudinal”, when referring to prime mover orientation, generally refers to an orientation of a crankshaft in an internal combustion engine or an orientation of an output shaft for an electric motor. A “transverse crankshaft engine” refers to an engine in which the crankshaft is perpendicular to a plane that divides the vehicle frame into left and right halves. A “longitudinal crankshaft engine” refers to an engine in which the crankshaft is contained in or parallel to a plane that divides the vehicle frame into left and right halves. A “transverse shaft motor” refers to a motor in which the output shaft is perpendicular to a plane that divides the vehicle frame into left and right halves. A “longitudinal shaft motor” refers to a motor in which the output shaft is contained in or parallel to a plane that divides the vehicle frame into left and right halves. A transverse orientation may also be referred to as an “east-west” or “left-right” orientation and a longitudinal orientation may also be referred to as a “north-south” or “front-rear” orientation.

A prime mover may be an engine such as an internal combustion engine (“IC engine” or “ICE”) or an electric motor. Control of a prime mover may be accomplished via signals from a control system. A control system may receive input from a human operator and convert that input into an output signal corresponding to a target power requirement for a drivetrain.

Internal combustion engine firing pulses may introduce torsional vibration in a drivetrain. A torsional damper may reduce vibrations to reduce rattle and premature wear on components or otherwise extend the life of a drivetrain. Various dampers may be used without affecting the operation of a CVT or the drivetrain. For example, a torsional damper with a long travel or otherwise torsionally soft dampening may be included, particularly for single cylinder engines. As the number of cylinders increases, torsional vibration may be managed in other ways.

Continuously variable transmissions (CVTs) may include continuously variable planetary transmissions (CVPs). A CVP traction drive is stiffer than a belt-pulley CVT, and torsional stiffness and characteristic inertia of a CVP may vary relative to ratio. In some configurations, a CVP may function as a U-drive, allowing power from a prime mover on a first side to pass through the CVP (via, for example, a shaft extending through a CVP) and exit the CVP on the same side as the prime mover. In other configurations, power from a prime mover may enter on one side of a CVP and exit the CVP on an opposite side.

Clutches may be used to selectively engage or disengage from a main shaft passing from a prime mover. Centrifugal clutches—which use centrifugal force to engage concentric shafts—are commonly used in scooters, mopeds, motorcycles, and other vehicles, to disengage the drivetrain and to prevent an internal combustion engine from stalling during braking.

Gear sets may change a speed or torque in a drive train. If a gear set uses a belt or chain, a first pulley or sprocket with a first gear radius is coupled by a chain (or belt or endless member) to a second pulley or sprocket with a second gear radius. If a gear set is a planetary gear set, by selectively locking or unlocking one or more of a sun gear, a set of planet gears, or a ring gear, a drive train can operate in low mode, high mode, forward mode, or reverse mode. In some configurations, power may be input through the sun gear, and if the ring gear is locked, power exits the set of planet gears, but in a reverse direction. Other gear sets are possible.

During operation of a drivetrain, a prime mover generates and delivers power at certain torque and speed levels, which depend on, among other things, various load requirements. A control system receives signals indicating operating conditions for one or more of the prime mover and CVP and sends control signals to one or more of the prime mover, clutch, CVP, and possibly a gear set, gear box or other mechanisms for providing a gear ratio (GR). The control signals sent to one or more of the prime mover, clutch, gear set, and CVP ensure a target performance of the drivetrain.
In some configurations, a gear set is a gear-chain system or otherwise provides a fixed gear ratio (GR). In other configurations, a gear set may be a planetary gear set such that multiple gear ratios are possible by selectively engaging one or more gears. A control unit may send signals to selectively engage gears in a gear set having multiple possible gear ratios.
In some configurations, signals indicating operating conditions of a prime mover are either not necessary or not received. However, in other configurations, signals indicating operating conditions of the prime mover are received, allowing configurations to take advantage of the capabilities of a CVP and optimize engine performance as well as the performance of the transmission, and an alternator or other accessory on a vehicle.
In some configurations, a clutch may be manually controlled. In other configurations, clutches are controlled automatically by the control unit. Configurations may also allow switching control of a clutch between manual and automatic modes.

To illustrate the advantages and characteristics of drivetrains incorporating CVTs (especially CVPs), various motorcycle drivetrain architectures are described. Those skilled in the art will appreciate after reviewing this disclosure that the exemplary concepts described herein may be useful for other vehicles having two or more wheels.

A drivetrain (such as in a motorcycle or scooter) may have components disposed on both sides relative to a lateral center of mass and at least partially in a longitudinal plane of the vehicle. For example, FIG. 1 depicts a schematic diagram of a drivetrain with a CVT. Drivetrain 100 includes prime mover 10 oriented transversely. Power exits prime mover 10 on a first side (conventionally referred to as the “right hand” or “right” side) to torsion damper 20 via coupling 51 and gear set 60 with a first gear ratio GR1. Orienting prime mover 10, gear box 75 and torsion damper 20 transversely may allow for reduced overall size, improved location of a center of gravity, improved cooling, or some other characteristic. Furthermore, torsion damper 20 may reduce the torsional vibration associated with the power exiting gear box 75.

Power exits torsion damper 20, crosses the longitudinal plane (to a “left hand” or “left” side), and changes from a transverse path to a longitudinal path via bevel gears 42A and 42B (collectively referred to as bevel gears 42-1), and enters CVP 30. Bevel gears 42-1 interposed between torsion damper 20 and CVP 30 may change power transmission from transverse to longitudinal and may further have a second gear ratio GR2 associated with gears 42A and 42B. In some configurations, GR2 is 1:1 indicating bevel gear 42-1 only changes the power transmission from transverse to longitudinal. In other configurations, GR2 is some other ratio, indicating bevel gear 42-1 may change the direction of power transmission and change a speed ratio.

Power enters CVP 30, where a tilt or other change adjusts a ratio of output speed relative to input speed. CVP 30 may be adjusted to a target speed ratio independent of the power generated by prime mover 10 or may be adjusted to a target speed ratio based on power generated by prime mover 10.

One of coupling 54 or 55 is engaged or disengaged by clutch 40, such that power exiting CVP 30 is allowed or prevented from reaching bevel gear 42-2 coupled to axle 56, which is coupled to wheel 50. Bevel gear 42-2 coupled to rear axle 56 may change power transmission from longitudinal to transverse and may further have a third gear ratio GR3. In some configurations, GR3 is 1:1 indicating bevel gear 42-2 only changes the power transmission from longitudinal to transverse. In other configurations, GR3 is some other ratio, indicating bevel gear 42-2 coupled to axle 56 may change the direction of power transmission and change a speed ratio.

FIG. 1 depicts a drivetrain having shafts or other couplings 51, 52, 53, 54, 55 and 56 for connecting two components. In some configurations, two or more shafts are combined, or components depicted in FIG. 1 can be coupled using other techniques and elements. For example, FIG. 1 depicts CVP 30 as coaxial with and coupled to output gear 42B of bevel gear 42-1 via coupling 53. In some configurations, output gear 42B of bevel gear 42-1 may be integrated with CVP 30 such that output gear 42B couples directly to CVP 30, eliminating coupling 53. Other combinations include using a gear/chain system, a belt/pulley system, or a bevel gear/shaft combination.

In operation, control unit 80 may send signals to prime mover 10 to generate power, which will have an associated torque and speed. The generated power is transmitted via coupling 51 through gear set 60 having first gear ratio GR1, through torsion damper 20 to bevel gear 42-1 having second gear ratio GR2, and through coupling 52 to CVP 30. Power exiting CVP 30 is transmitted via coupling 54, through clutch 40 and coupling 55 to bevel gear 42-2 coupled to coupling 56, with bevel gear 42-2 coupled to coupling 56 having a third gear ratio GR3. Control unit 80 controls CVP 30 such that power exiting CVP 30 rotates wheel 50 at a target rate (revolutions per minute).

Some configurations of a drivetrain may have components located on one side of a longitudinal plane of the drivetrain or balanced relative to a longitudinal plane of the vehicle. An advantage to having all components on the same side of the longitudinal plane, in series (and possibly even coaxial) may include manufacturability, compactness of the drivetrain and maintenance. FIG. 2 depicts a schematic diagram of a drivetrain with a CVP, in which all components are disposed on one side of a longitudinal plane of the vehicle and coaxial with each other. Drivetrain 200 includes prime mover 10 oriented longitudinally. Power exits prime mover 10 via coupling 51 to torsion damper 20 and exits torsion damper 20 via coupling 61 to gear box 75 with a first gear ratio (GR1). Orienting prime mover 10, gear box 75 and torsion damper 20 longitudinally may eliminate bevel gears, gear-chain sets, or other components, and therefore may allow for a more compact design of drivetrain 200. Torsion damper 20 may reduce the torsional vibration associated with the power exiting prime mover 10 before the power enters gear box 75. Power from gear box 75 is transmitted via coupling 62 to CVP 30.

Power enters CVP 30, where a tilt or other change adjusts a ratio of output speed relative to input speed. CVP 30 may be adjusted to a target speed ratio independent of the power generated by prime mover 10 or may be adjusted to a target speed ratio based on power generated by prime mover 10.

Power may exit CVP 30 via coupling 63 and enter gears 70, and exit gears 70 via coupling 64 to clutch 40. Coupling 64 may be engaged or disengaged from wheel 50 by clutch 40, such that power exiting gear box 70 is controlled by clutch 40. Control unit 80 may be communicatively coupled to one or more of prime mover 10, gear box 75 having multiple gear ratios (GRs), CVP 30, clutch 40, and gear 70 having a gear ratio (GR) or multiple gear ratios (GRs) and may receive sensor signals from any of a plurality of sensors associated with components on the vehicle or environmental conditions. For example, control unit 80 is configurable to control CVP 30 independently of a speed of a motorcycle, yet a speed sensor capable of determining motorcycle speed may be received by control unit 80 in some configurations. Furthermore, FIG. 2 depicts a drivetrain having couplings 51, 61, 62, 63 and 64. In some configurations, two or more couplings are combined, or components depicted in FIG. 2 can be coupled using other techniques and elements. For example, FIG. 2 depicts CVP 30 as downstream from gear box 75. In some configurations, CVP 30 may be directly coupled to gear box 75.

In operation, control unit 80 may send signals to prime mover 10 to generate power, which will have an associated torque and speed. The generated power is transmitted via coupling 51 through torsion damper 20 through coupling 61 to gear box 75 having multiple gear ratios (GRs). Power from gear box 75 is transmitted via coupling 62 to CVP 30. CVP 30 may be adjusted for a target output torque or speed. Power from CVP 30 may be transmitted via coupling 63 to gear 70 having a gear ratio (GR) or multiple gear ratios (GRs), and from gear 70 via coupling 64 to wheel 50 depending on an engagement state of clutch 40.

A drivetrain may have some components located forward of the drivetrain and other components located at the back of the drivetrain. For example, FIG. 3 depicts a schematic diagram of a drivetrain with select components located separately from other components. An advantage to separating components may be the ability to have a portion of the motorcycle as sprung (or unsprung) weight or to allow for improved airflow around components. Drivetrain 300 includes prime mover 10 oriented transversely and coupled to torsion damper 20 located on a left-hand side of drivetrain 300. In this arrangement, airflow around the front of drivetrain 300 need only cool prime mover 10 and torsion damper 20. Furthermore, prime mover 10 and torsion damper 20 may be positioned on a first side of a frame hinge for unsprung weight. Power exits prime mover 10 on the left-hand side to torsion damper 20 coupled to gear-chain set 60 having a gear ratio (GR) or multiple gear ratios (GRs). Torsion damper 20 may reduce the torsional vibration associated with the power exiting prime mover 10 before the power enters CVP 30. Gear-chain set 60 having a gear ratio (GR) or multiple gear ratios (GRs)allows prime mover 10 and torsion damper 20 to be located on a first side of (Including coaxial with) a frame hinge and provide power to CVP 30 located on a second side of the frame hinge. Power may enter CVP 30 and exit through clutch 40 to shaft 65 extending through CVP 30 to gear box 75 having multiple gear ratios (GRs). CVP 30 may be adjusted to a target speed ratio independent of the power generated by prime mover 10 or may be adjusted based on the power generated by prime mover 10. CVP 30 is engaged or disengaged from gear box 75 by clutch 40.

Control unit 80 may be communicatively coupled to one or more of prime mover 10, CVP 30, clutch 40, and gear box 75 having multiple gear ratios (GRs) and may receive sensor signals from any of a plurality of sensors associated with components on the vehicle or environmental conditions. For example, control unit 80 is configurable to control CVP 30 independently of a speed of a motorcycle, yet a speed sensor capable of determining motorcycle speed may be received by control unit 80 in some configurations. Furthermore, FIG. 3 depicts a drivetrain having shaft 65 extending through CVP 30 to clutch 40. In some configurations, components depicted in FIG. 3 can be coupled using other techniques and elements.

A drivetrain may have components located primarily on a forward side of a frame hinge and at least partially in a plane of the vehicle that divides the vehicle into left hand and right-hand sides. FIG. 4 depicts a schematic diagram of a drivetrain with an embodiment of a CVP. Drivetrain 400 includes prime mover 10 oriented longitudinally. Power exits prime mover 10 via coupling 51 to torsion damper 20, via coupling 52 to CVP 30, and via coupling 54 to clutch 40. Power exiting clutch 40 may pass through bevel gear 42 (comprising gears 42A and 42B) having a gear ratio (GR) to gear-chain set 60 to wheel 50. Bevel gear 42 may be positioned coaxial with a frame hinge, or gear-chain set 60 may allow prime mover 10, torsion damper 20, CVP 30 and clutch 40 to be positioned forward of a frame hinge and power may be transmitted by gear-chain set 60 having a gear ratio (GR) to wheel 50. Coupling 57 could be a universal joint so that a wheel assembly can move relative to the frame. CVP 30 may be adjusted to a target speed ratio independent of the power generated by prime mover 10. CVP 30 is engaged or disengaged from wheel 50 by clutch 40.

In operation, control unit 80 may send signals to prime mover 10 to generate power, which will have an associated torque and speed. The generated power is transmitted via coupling 51 to torsion damper 20, through coupling 52 to CVP 30, through coupling 54 to clutch 40, through bevel gear 42 having a first gear ratio (GR) and gear-chain set 60 having a second gear ratio (GR) to wheel 50. Control unit 80 may be communicatively coupled to one or more of prime mover 10, torsion damper 20, CVP 30, and clutch 40, and may receive sensor signals from any of a plurality of sensors associated with components on the vehicle or environmental conditions. For example, control unit 80 is configurable to control CVP 30 independent of a speed of a motorcycle, yet a speed sensor capable of determining motorcycle speed may be received by control unit 80 in some configurations. Furthermore, FIG. 4 depicts a drivetrain having couplings 51, 52, and 54, and bevel gears 42. In some configurations, two or more shafts are combined, or components depicted in FIG. 4 can be coupled using other techniques and elements. For example, FIG. 4 depicts CVP 30 as coaxial with and coupled via coupling 57 to input gear 42A of bevel gear set 42. In some configurations, input gear 42A may be integrated with CVP 30 such that output gear 42B couples directly to CVP 30, eliminating coupling 57. Other combinations and omissions include using a gear/chain system, a belt/pulley system, or a bevel gear/shaft combination having a gear ratio (GR) or multiple gear ratios (GRs).

A drivetrain may have components located primarily on a forward side of a frame hinge but not restricted to a plane of the vehicle. FIG. 5 depicts a schematic diagram of a drivetrain with a CVP. Drivetrain 500 includes prime mover 10 oriented transversely. Power exits prime mover 10 on the right-hand side to torsion damper 20 via gear-chain set 60A having a gear ratio (GR) or multiple gear ratios (GRs). Orienting prime mover 10, gear-chain set 60A and torsion damper 20 transversely may reduce torsional vibration or make it less noticeable to a rider on a motorcycle. Furthermore, torsion damper 20 may reduce the torsional vibration associated with the power before the power enters CVP 30. CVP 30 may be adjusted to a target speed ratio independent of the power generated by prime mover 10. CVP 30 is engaged or disengaged from wheel 50 by clutch 40.

Furthermore, FIG. 5 depicts a drivetrain having couplings 51, 52, 54 and 57, and gear-chain sets 60A and 60B having first gear ratio GR1 and second gear ratio GR2, respectively. In some configurations, two or more shafts are combined, or components depicted in FIG. 5 can be coupled using other techniques and elements. For example, FIG. 5 depicts clutch 40 as offset from a front gear in gear-chain set 60B. In some configurations, clutch 40 and a front gear of gear-chain set 60B may be coaxial. Other combinations include using a gear/chain system, a belt/pulley system, or a bevel gear/shaft combination having a gear ratio (GR) or multiple gear ratios (GRs).

In operation, control unit 80 may send signals to prime mover 10 to generate power, which will have an associated torque and speed. The generated power is transmitted via coupling 51 through gear-chain set 60A having a gear ratio (GR), through torsion damper 20, through coupling 52 to CVP 30. Power from CVP 30 transmitted via coupling 54 to clutch 40, through coupling 57, gear-chain set 60B having a gear ratio (GR) and shaft 65 to wheel 50.

A drivetrain may have components disposed on a forward side of a frame hinge and oriented transversely. FIG. 6 depicts a schematic diagram of one configuration of a drivetrain with a CVP. Drivetrain 600 includes prime mover 10, torsion damper 20, gear box 75 having multiple gear ratios (GRs), and CVP 30 oriented transversely. Power exits prime mover 10 through coupling 51 to torsion damper 20, through coupling 61 to gear box 75 having multiple gear ratios (GRs), through coupling 62 to CVP 30. In this configuration, CVP 30 may function as a U-drive, allowing power from prime mover 10 on a first side to pass through CVP 30 (via, for example, coupling 62 extending through CVP 30) and exit CVP 30 on the same side as prime mover 10 to clutch 40, through gear-chain set 60 (with an associated gear ratio GR1) to axle 65 coupled to wheel 50. Orienting prime mover 10, gear box 75 and torsion damper 20 transversely may reduce torsional vibration or make it less noticeable to a rider on a motorcycle. Furthermore, torsion damper 20 may reduce the torsional vibration associated with the power exiting prime mover 10 before the power enters gear box 75, which could multiply the negative effects of torsional vibrations. CVP 30 may be adjusted to a target speed ratio independent of the power generated by prime mover 10 or may be adjusted based on the power generated by prime mover 10. CVP 30 is engaged or disengaged from wheel 50 by clutch 40. Control unit 80 may be communicatively coupled to one or more of prime mover 10, CVP 30, and gear box 75, and may receive sensor signals from any of a plurality of sensors associated with components on the vehicle or environmental conditions. For example, control unit 80 is configurable to control CVP 30 independently of a speed of a motorcycle, yet a speed sensor capable of determining motorcycle speed may be received by control unit 80 in some configurations. Furthermore, FIG. 6 depicts a drivetrain having shafts 51, 61 and 62. In some configurations, two or more couplings are combined, or components depicted in FIG. 6 can be coupled using other techniques and elements. Other combinations include using a gear/chain system, a belt/pulley system, or a bevel gear/shaft combination.

In operation, control unit 80 may send signals to prime mover 10 to generate power, which will have an associated torque and speed. The generated power is transmitted via coupling 51 to torsion damper 20, through coupling 61 to gear box 70 having a gear ratio (GR) or multiple gear ratios (GRs), through coupling 62 to CVP 30, to clutch 40. Drive train 600 may be located forward, coplanar (including coaxial) with, or rear of a frame hinge.

A drivetrain may have components disposed on two axes in the vehicle. FIG. 7 depicts a schematic diagram of a drivetrain with two axes. Drivetrain 700 includes prime mover 10, clutch 40 and a front gear set 60 having a gear ratio (GR) oriented transversely and located coaxially on a first axis. Power exits prime mover 10 through coupling 71 to clutch 40, through coupling 72 to a front gear of gear-chain set 60 having a gear ratio (GR). Prime mover 10, clutch 40 and the front gear of gear-chain set 60 may be located forward of, rearward of, or coplanar (including coaxial) of a frame hinge. Power passes through gear-chain set 60 having a first gear ratio GR1 to gear box 75, through shaft 65 to CVP 30 integrated into wheel 50. In this configuration, wheel 50, CVP 30 and gear box 75 are coaxial about a second axis. Absence of a torsion damper may be result in reduced weight and complexity, and gear-chain set 60 may also reduce torsional vibration. CVP 30 may be adjusted to a target speed ratio independent of the power generated by prime mover 10 or may be adjusted based on power generated by prime mover 10. Clutch 40 may engage or disengage power to gear box 75.

Control unit 80 may be communicatively coupled to one or more of prime mover 10, CVP 30, clutch 40, and gear box 75, and may receive sensor signals from any of a plurality of sensors associated with components on the vehicle or environmental conditions. For example, control unit 80 is configurable to control CVP 30 independently of a speed of a motorcycle, yet a speed sensor capable of determining motorcycle speed may be received by control unit 80 in some configurations. Furthermore, FIG. 7 depicts a drivetrain having couplings 71, 72, and 65. In some configurations, two or more shafts are combined, or components depicted in FIG. 7 can be coupled using other techniques and elements. Other combinations include using a gear/chain system, a belt/pulley system, or a bevel gear/shaft combination.

In operation, control unit 80 may send signals to prime mover 10 to generate power, which will have an associated torque and speed. The generated power is transmitted via shaft 71 to clutch 40, through shaft 72 and gear-chain set 60 having an associated gear ratio GR1 to gear box 75, through shaft 65 to CVP 30 in wheel 50.

A drivetrain may have selected components disposed on an axis between a prime mover axis and a wheel axis. FIG. 8 depicts a schematic diagram of a drivetrain with a prime mover on a first axis, a CVP and other components on a second axis, and a wheel on a wheel axis. Drivetrain 800 includes prime mover 10 oriented transversely. Power exits prime mover 10 on the right-hand side through coupling 51 to gear-chain set 60A (having a first gear ratio GR1) passing through torsion damper 20 to gear box 75 (having a set of gear ratios GRs), through coupling 62 to CVP 30, through coupling 54 to clutch 40, through coupling 57, bevel gears 42A and 42B (collectively referred to herein as bevel gears 42-1) having a second gear ratio (GR2) and bevel gears 42A and 42B (collectively referred to herein as bevel gears 42-2) having a third gear ratio (GR3) through shaft 65 to wheel 50. Orienting prime mover 10, torsion damper 20, gear box 75, CVP 30 and clutch 40 transversely may reduce torsional vibration or make it less noticeable to a rider on a motorcycle. Furthermore, torsion damper 20 may reduce the torsional vibration associated with the power entering gear box 75 before the power enters CVP 30. CVP 30 may be adjusted to a target speed ratio independent of the power generated by prime mover 10. CVP 30 is engaged or disengaged from wheel 50 by clutch 40, such that power exiting CVP 30 is controlled by clutch 40. In some embodiments, a universal “u-joint” (not shown) is positioned between bevel gears 42-1 and 42-2 to allow wheel 50 to move independent of 10, 30, and 40.

Control unit 80 may be communicatively coupled to one or more of prime mover 10, torsion damper 20, CVP 30, clutch 40, and gear box 75, and may receive sensor signals from any of a plurality of sensors associated with components on the vehicle or environmental conditions. For example, control unit 80 is configurable to control CVP 30 independently of a speed of a motorcycle, yet a speed sensor capable of determining motorcycle speed may be received by control unit 80 in some configurations. Furthermore, FIG. 8 depicts a drivetrain having couplings 51, 62, 54 and 57 and bevel gears 42-1 and 42-2. In some configurations, two or more couplings are combined, or components depicted in FIG. 8 can be coupled using other techniques and elements. FIG. 8 depicts clutch 40 as coaxial with and coupled via coupling 57 to input gear 42A of bevel gear set 42-1 having a first gear ratio GR1. In some configurations, input gear 42A may be integrated with clutch 40 such that output gear 42B couples directly to clutch 40, eliminating coupling 57. Other combinations include using a gear/chain system, a belt/pulley system, or a bevel gear/shaft combination.

In operation, control unit 80 may send signals to prime mover 10 to generate power, which will have an associated torque and speed. The generated power is transmitted via coupling 51 through gear-chain set 60A (including torsion damper 20), to gear box 75, through coupling 62 to CVP 30. Power from CVP 30 is transmitted via coupling 54 to clutch 40 and from clutch 40 through bevel gears 42-1 and 42-2 (two sets) and shaft 65 to wheel 50. Gear box 75 may be configured for a target output torque or speed. For example, power may enter a planetary gear set via an outer ring, may exit via a sun gear. Alternatively, a planetary gear set may be configured to allow power to enter via a carrier, a sun gear, a planet gear or some combination.

Similarly, FIGS. 9-20 depict various configurations of drivetrain architectures 900, 1000, 1100, 1200, 1300, 1400, 1500, 1600, 1700, 1800, 1900 and 2000, possible for scooters, motorcycles and other vehicles, illustrating the versatility of drivetrains made possible in part due to the presence of a CVP in the drivetrain.

FIG. 9 depicts a schematic diagram, in which drivetrain 900 includes prime mover 10, torsion damper 20, gears (which may include a gear box) 70, clutch 40, CVP 30 and a first gear of gear set 60 coaxial about a longitudinal axis. U-joint 85 allows wheel 50 to move independently of other components in a drivetrain, such as prime mover 10, torsion damper 20, gears 70, clutch 40, CVP 30, and a first gear of gear set 60.

FIG. 10 depicts a schematic diagram of drivetrain 1000, in which prime mover 10, torsion damper 20, and clutch 40 are on a first axis and coupled to CVP 30 via gear 70 having a first gear ratio (GR1). CVP 30 is arranged on its own axis and coupled via chain-sprocket assembly 60 having a second gear ratio (GR2) to an axle associated with wheel 50.

FIG. 11 depicts a schematic diagram, in which drivetrain 1100 includes prime mover 10, torsion damper 20, gears (which may include a gear box) 70, CVP 30, clutch 40, and a first gear of gear set 60 coaxial about a longitudinal axis. U-joint 85 allows wheel 50 to move independently of other components in a drivetrain.

FIG. 12 depicts a schematic diagram, in which drivetrain 1200 includes prime mover 10 and torsion damper 20 coaxial about a longitudinal axis, a first gear set (which may include a gear box) 70 with first gear ratio (GR1) allowing a first offset to CVP 30 and clutch 40 coaxial about a second axis parallel to the longitudinal axis, and a first gear of gear set 60 having a second gear ratio (GR2) allowing a second offset to a third axis. U-joint 85 may allow wheel 50 to move independently of other components in a drivetrain.

FIG. 13 depicts a schematic diagram, in which drivetrain 1300 includes prime mover 10 and torsion damper 20 coaxial about a transverse axis, first gear set (which may include a gear box) 70 with first gear ratio (GR1) coupled to CVP 30 and clutch 40 coaxial about a second axis transverse to a longitudinal axis, and a first gear of gear set 60 providing a second offset to a third axis associated with an axle of wheel 50. CVP 30 may function as a U-drive.

FIG. 14 depicts a schematic diagram, in which drivetrain 1400 includes prime mover 10 and torsion damper 20 coaxial about a transverse axis, first gear set 70 with first gear ratio (GR1) coupled to CVP 30, clutch 40 coaxial about a second axis transverse to a longitudinal axis, and gear sets 60 (having gear ratios GR2 and GR3) transmitting power to a third axis associated with an axle of wheel 50.

FIG. 15 depicts a schematic diagram, in which drivetrain 1500 includes prime mover 10 and torsion damper 20 coaxial about a transverse axis, first gear set (which may include a gear box) 70 with first gear ratio (GR1) coupled to CVP 30 and clutch 40 coaxial about a second axis transverse to a longitudinal axis, and gear sets 60 (having gear ratios GR2 and GR3, respectively) transmitting power to a third axis associated with an axle of wheel 50. In this configuration, torsion damper 20 may be on a first side and at least a portion of gear set 60 may be on an opposite side relative to a longitudinal plane of the motorcycle.

FIG. 16 depicts a schematic diagram, in which drivetrain 1600 includes prime mover 10, torsion damper 20, first gear set 60 with first gear ratio (GR1), CVP 30, and clutch 40 coaxial about a first transverse axis, second gear set 60 (which may include second gear ratios (GR2, GR3) coupled to a third axis associated with an axle of wheel 50.

FIG. 17 depicts a schematic diagram, in which drivetrain 1700 includes prime mover 10, torsion damper 20, gear set 60 with first gear ratio (GR1), CVP 30, and clutch 40 coaxial about a first transverse axis, second gear set (which may include a gear box) 60 with second gear ratios (GR2, GR3) coupled to a second axis associated with an axle of wheel 50.

FIG. 18 depicts a schematic diagram, in which drivetrain 1800 includes prime mover 10 and torsion damper 20 coaxial about a first transverse axis, CVP 30 and clutch 40 coaxial about a second transverse axis that is coupled to the first transverse axis by gear set 70 having a first gear ratio (GR1), second gear set (which may include a gear box) 60 with second gear ratios (GR2, GR3) coupled to a second axis associated with an axle of wheel 50.

FIG. 19 depicts a schematic diagram, in which drivetrain 1900 includes prime mover 10 and torsion damper 20 coaxial about a first transverse axis, gear set 60 with first gear ratio (GR1), CVP 30 and clutch 40 coaxial about a second transverse axis, second gear set 60 with second gear ratios (GR2A, GR2B) coupled to a third axis associated with an axle of wheel 50. CVP 30 may function as a u-drive, with power entering and exiting CVP 30 on the same side.

FIG. 20 depicts a schematic diagram, in which drivetrain 2000 includes prime mover 10 and torsion damper 20 coaxial about a first transverse axis, gear set 60 with first gear ratio (GR1), clutch and CVP 30 coaxial about a second transverse axis, second gear set 60 with a second gear ratio (GR2A) coupled to a third axis associated with an axle of wheel 50. In some embodiments, CVP 30 and clutch 40 may function as a u-drive, with CVT 30 functioning as a through drive and a separate independent central thru shaft.

### SUMMARY

There exists a continuing need for CVTs, both as independent systems and as subassemblies integrated with existing technologies, in a multitude of powered applications.

In some systems, it would be beneficial to operate an electric motor or an internal combustion engine at an optimal speed and have a power modulating device manage vehicle speed for optimal acceleration, efficiency or range.

Embodiments disclosed herein may be based on any of the foregoing examples in accordance with OEM (Original Equipment Manufacturer) requirements for new design options for market differentiation. A configuration may be desirable to an OEM based solely on the ability for the OEM to market the configuration as unique. For example, a configuration may allow for a new design not previously available, or may allow for target functionality, such as a step through frame. A profile may be smoother for better aerodynamics or laterally extended for improved cooling of components. Components may be combined or positioned behind fairings for a more streamlined appearance. Components may be positioned based on one or more factors such as cooling (including positioning hotter components farther from a rider), noise reduction or abatement, ease of manufacturing, assembly, testing or maintenance, ability to have a sealed drivetrain or portion thereof to avoid ingress of dirt, water or cooling fluids, or allow for jack points or other serviceability requirements or desires. In some embodiments and configurations, off-the-shelf (existing), lighter, or smaller components may be desirable to reduce the overall weight of the motorcycle or to control a center of balance for the motorcycle, reduce unsprung weight for the motorcycle, etc. Embodiments may be selected to allow for improvements in swing arm design, clutch design, shock design, brake design, hub/rim design, and may further use right-angle gears, gear boxes, or other gear designs. Furthermore, embodiments disclosed above may work better for different prime movers. For example, internal combustion engines in motorcycles typically range from 50 cc to 2100 cc. A drivetrain configuration for a 50 cc engine may have different requirements and may therefore differ from a drivetrain for a 2100 cc engine.

In some embodiments, individual customization is possible. For example, a drivetrain may be controlled electronically to reduce torsional vibrations. Electronic control may include using information provided directly by a user or by using feedback from sensors indicating a driving style or intended use of a scooter or motorcycle. There may be certain sensors (including placement of the spacers) used to gather information about the scooter. This may include direct measurement (which might be more accurate but require more sensors) or inferential determination (which would reduce the number of sensors but require more processing, such as noise handling, etc.). Empirical data may be analyzed to determine usable life of components, when components need to be serviced, if a warranty claim is valid, etc. Sensor information on a scooter may be integrated with sensor information received from a smart phone (e.g., getting accelerometer data from a cell phone to determine acceleration speed of the scooter during an event, getting sensor information from sensors on the scooter, and determining a driving or operational style of the rider—hard acceleration vs. easy speed ups, exceeding a maximum vehicle speed limit or weight limit, etc.). In some embodiments, features or functionality may be integrated into a smart phone application that is usable “out of the box” but adapts over time to that user. One possible drawback for any drivetrain architecture is thermal management, especially in architectures in which air cooling is a significant (if not the dominant) factor to consider. Thus, while a compact and lightweight engine behind an aerodynamic fairing may be beneficial, cooling the engine may present additional problems, such as the additional weight, size and costs of a radiator, fluid reservoir and other components of a water-cooled system. If a water-cooled system is not feasible, then the drivetrain itself or architecture of the drivetrain may be limited in terms of what components need higher air flow, which components cannot be located near each other, where components should be located to minimize risk of burning a rider, where components should be located to minimize noise, and the like.

Embodiments illustrated and described herein have several features, no single one of which is solely responsible for its desirable attributes.

In one broad respect, embodiments may be generally directed to a system for lubricating a ball-planetary continuously variable transmission. The CVP may have a rotatable hub shell containing a plurality of spherical planets arranged around a main axle defining a longitudinal axis of rotation, each spherical planet having a planet axle defining a planet axis of rotation, wherein tilting the planet axes of rotation changes a speed ratio of the CVT. The rotatable hub shell is configured for retaining a lubrication fluid. The lubrication system comprises a lubrication tube for supplying lubrication to radially inward components. The lubrication tube comprises a first end extending radially outward with an orifice at the first end and a second end extending radially inward with an opening at the second end. Rotation of the hub shell causes lubrication fluid to enter the orifice, flow along the tube, and exit the opening. In some embodiments, the hub shell has an interior surface, wherein the first end of the tube extends to a radial distance proximate to the interior surface. In some embodiments, the interior surface of the hub shell is smooth or comprises a feature for controlling fluid flow. In some embodiments, the orifice is complementary to a profile of the interior surface. In some embodiments, the orifice cross-section is one of circular, tear drop, angled, or asymmetric. In some embodiments, the feature comprises a circumferential groove, wherein lubrication fluid flows into the circumferential groove. In some embodiments, the orifice is shaped as complementary to the circumferential groove. In some embodiments, the opening and a component of the CVT are located at a same radial position. In some embodiments, the component comprises a spherical planet. In some embodiments, an outer surface of the tube is configured for contact with the lubrication fluid, whereby lubrication fluid flows radially inward along the outer surface of the tube. In some embodiments, the tube is fixed to a non-rotatable component of the CVT. In some embodiments, the tube is coupled to a carrier.

### BRIEF DESCRIPTION OF THE DRAWINGS

The accompanying figures, which are incorporated in and form a part of the specification, illustrate certain features of the inventive embodiments.

FIGS. 1-20 depict schematic diagrams of configurations of drivetrains having a continuously variable transmission forming a part thereof;

FIGS. 21-24 depict schematic diagrams of CVPs, illustrating U-drive and through drive embodiments of CVPs; and

FIGS. 25A-25C depict partial cut-away views of a portion of a CVP, illustrating one embodiment of a lubrication system.

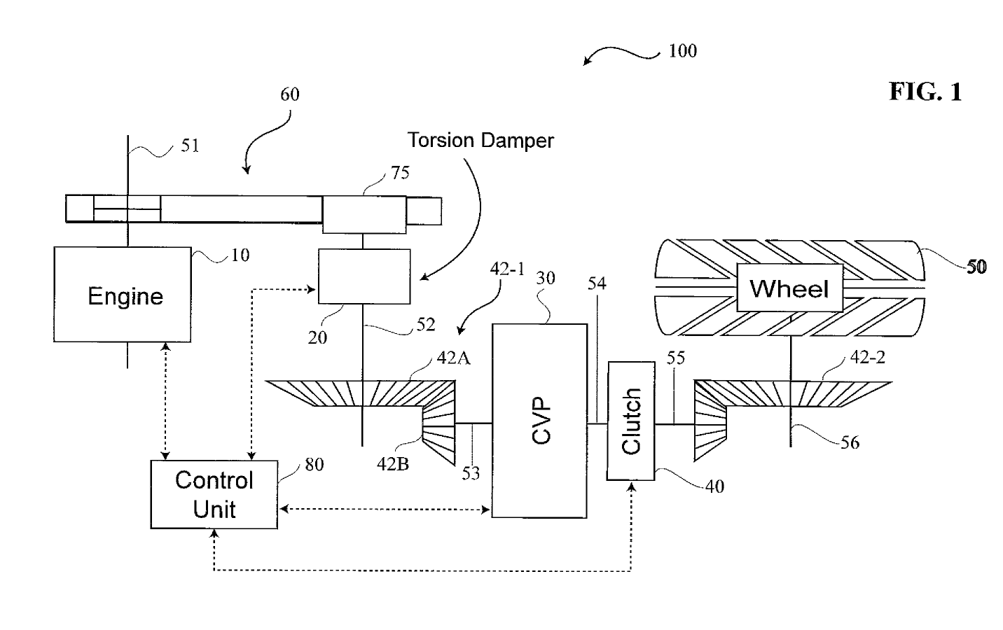

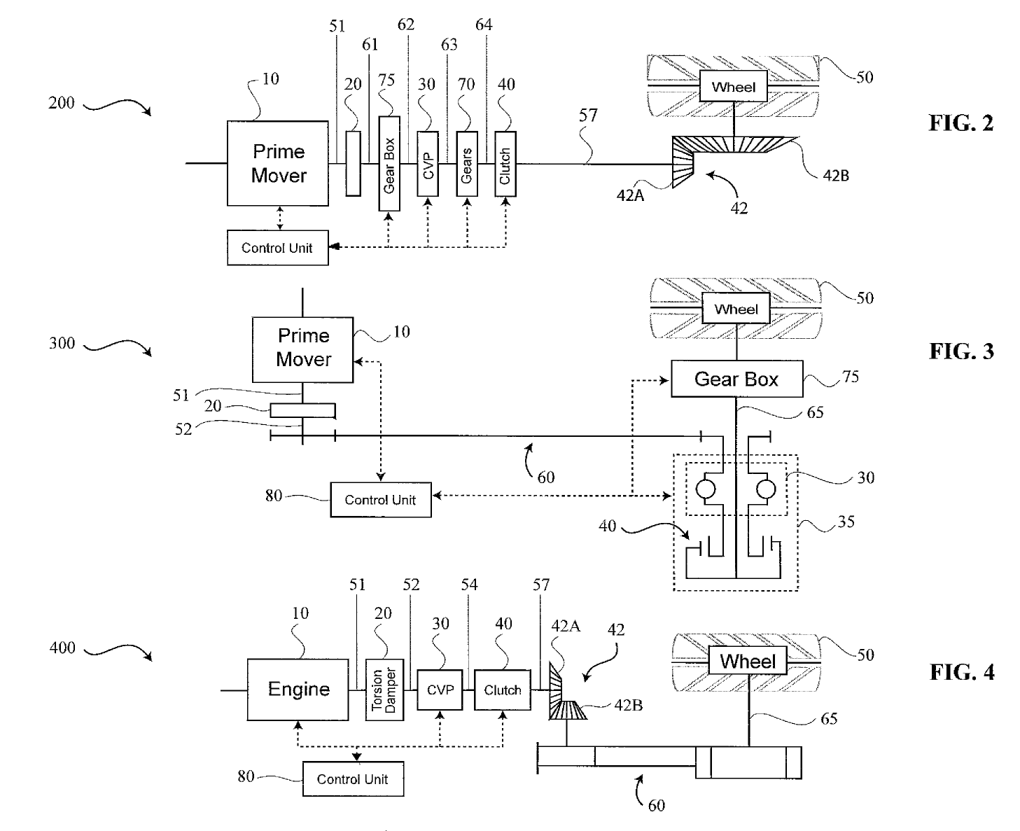

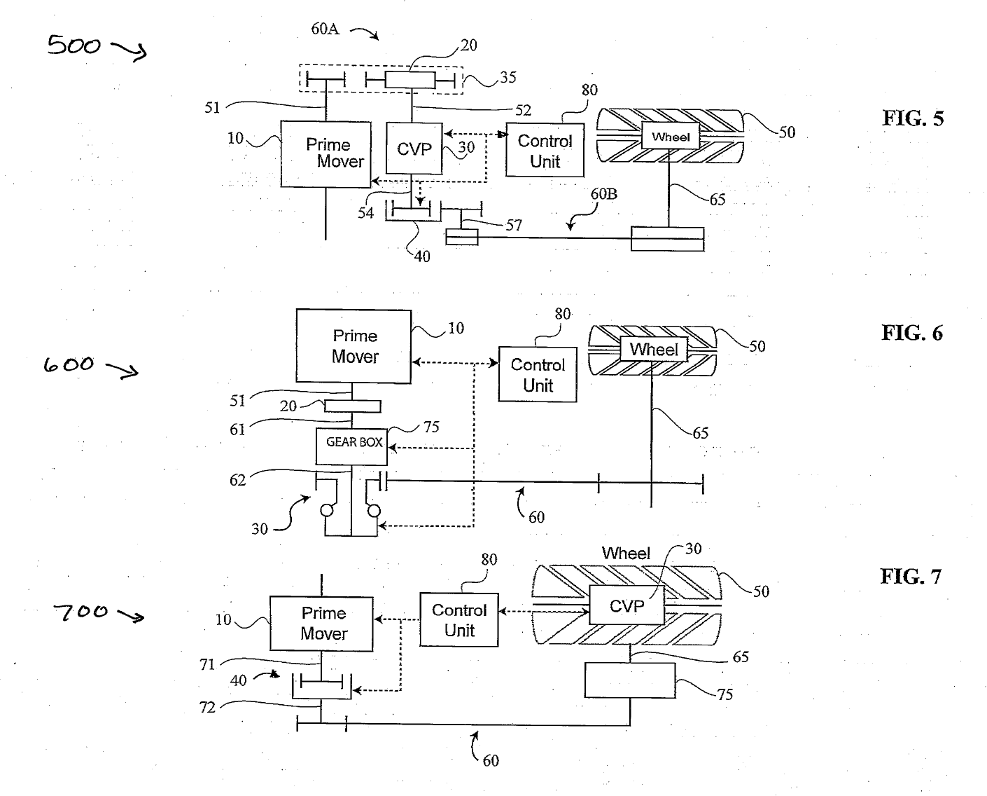

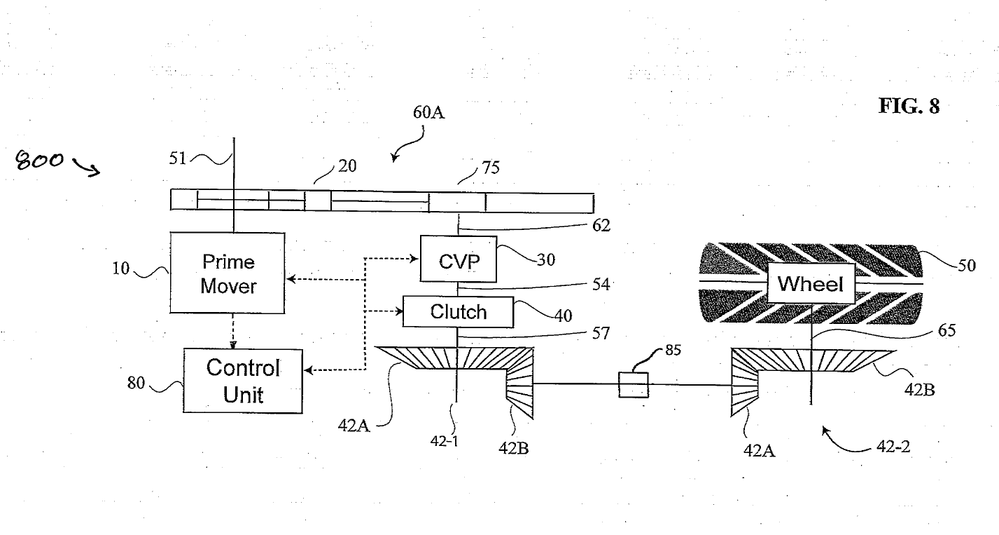

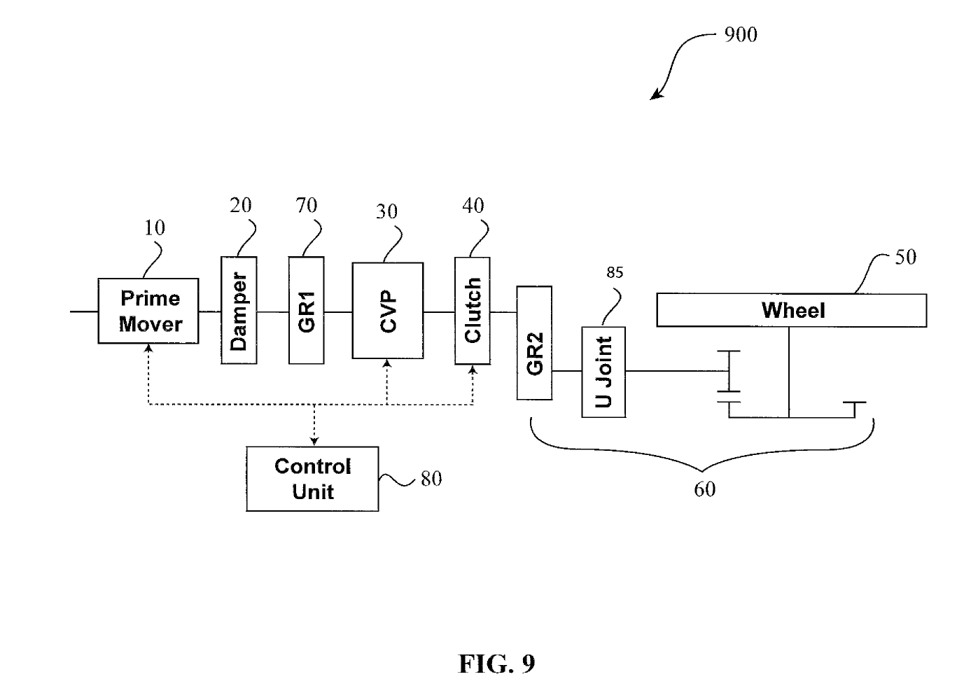

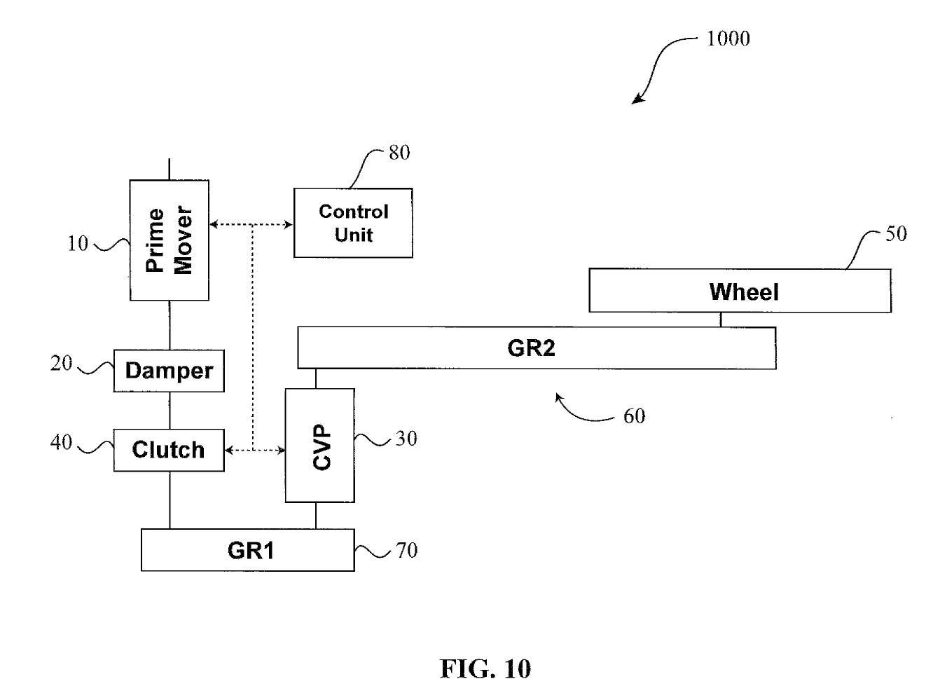

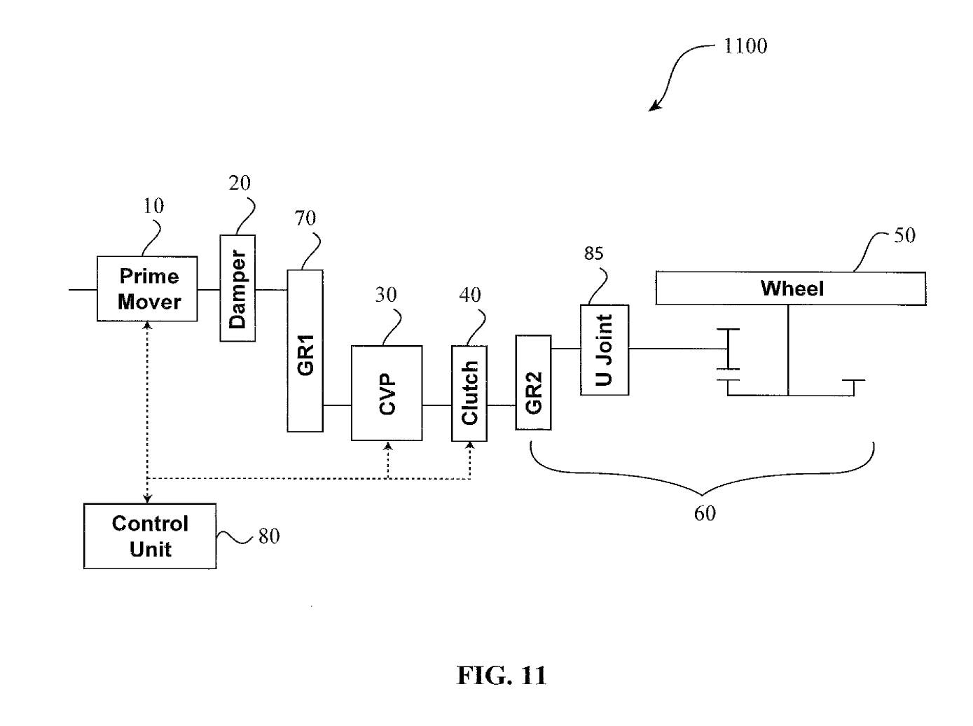

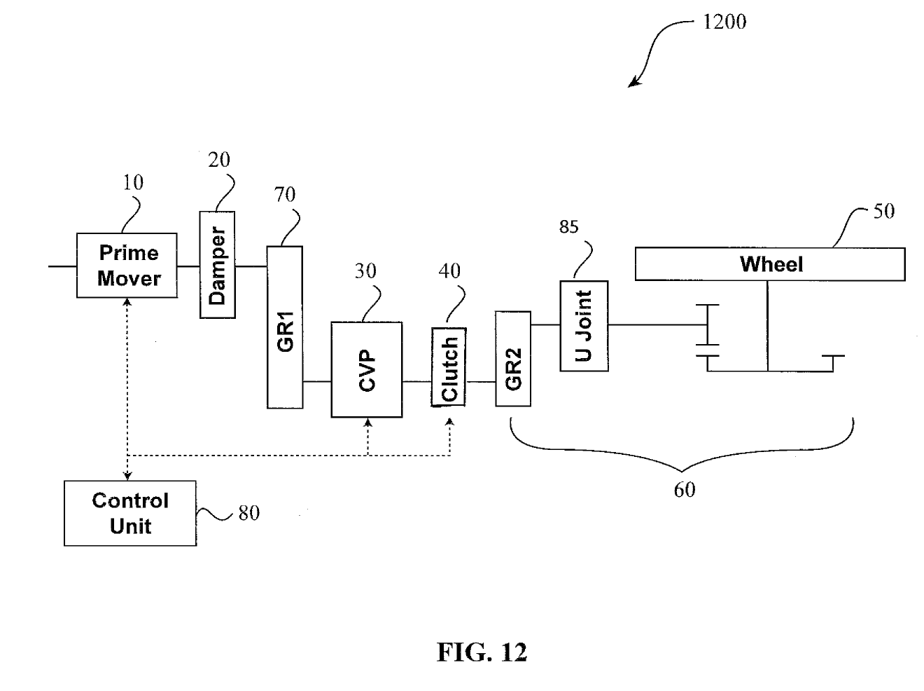

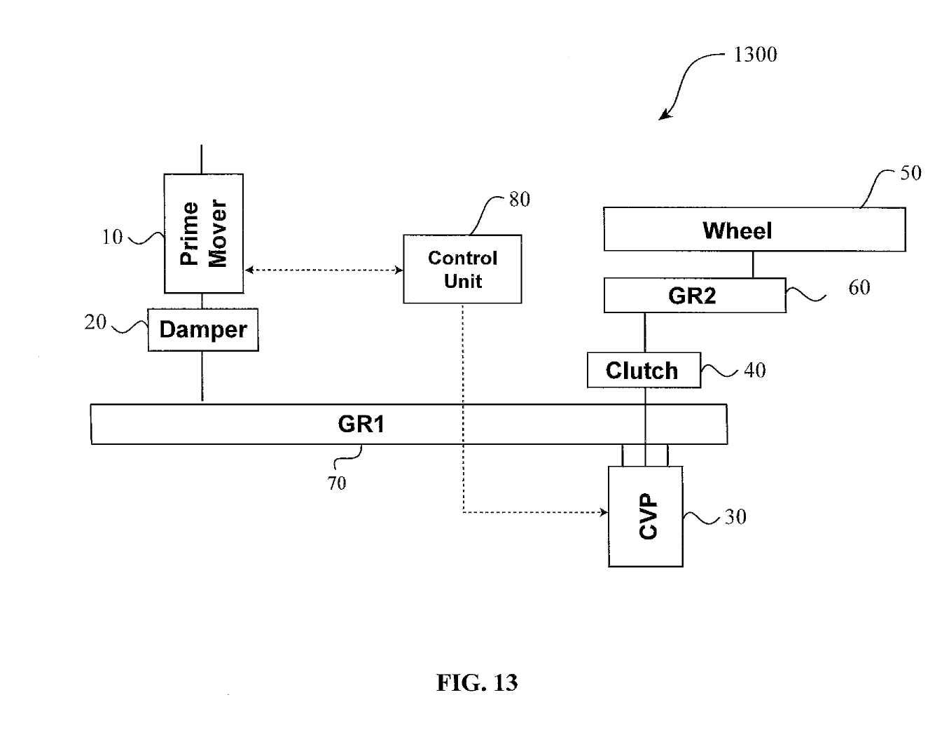

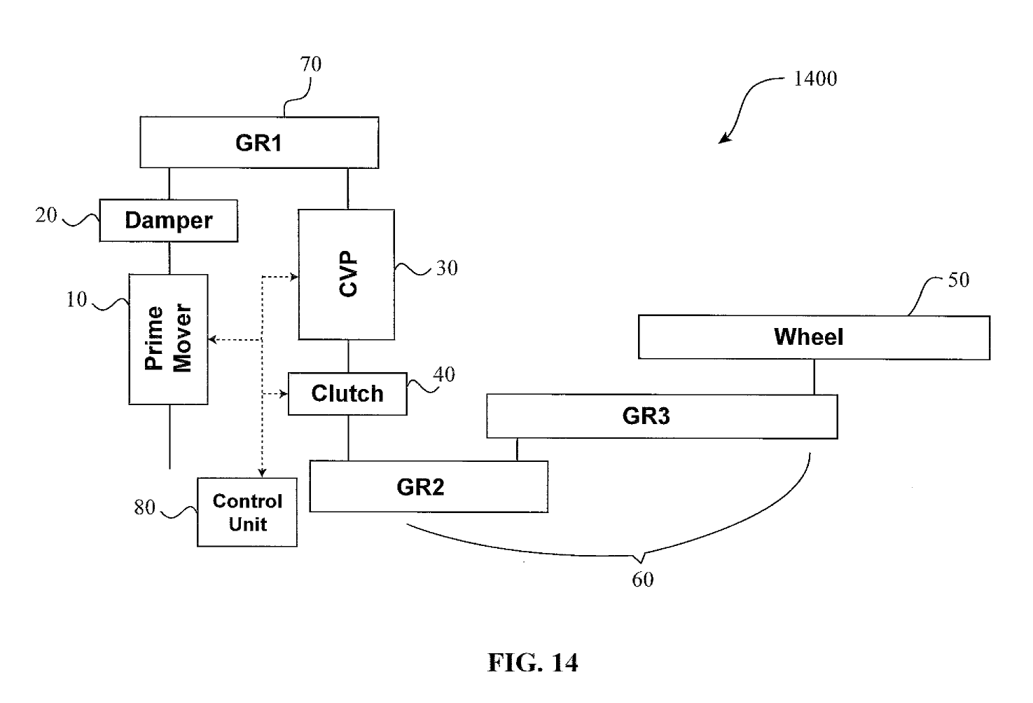

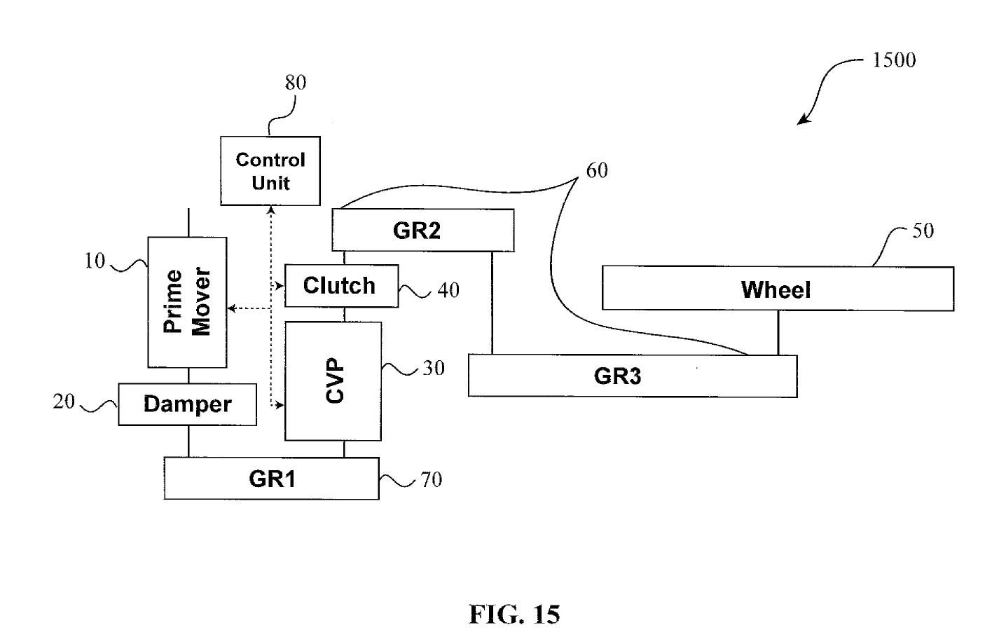

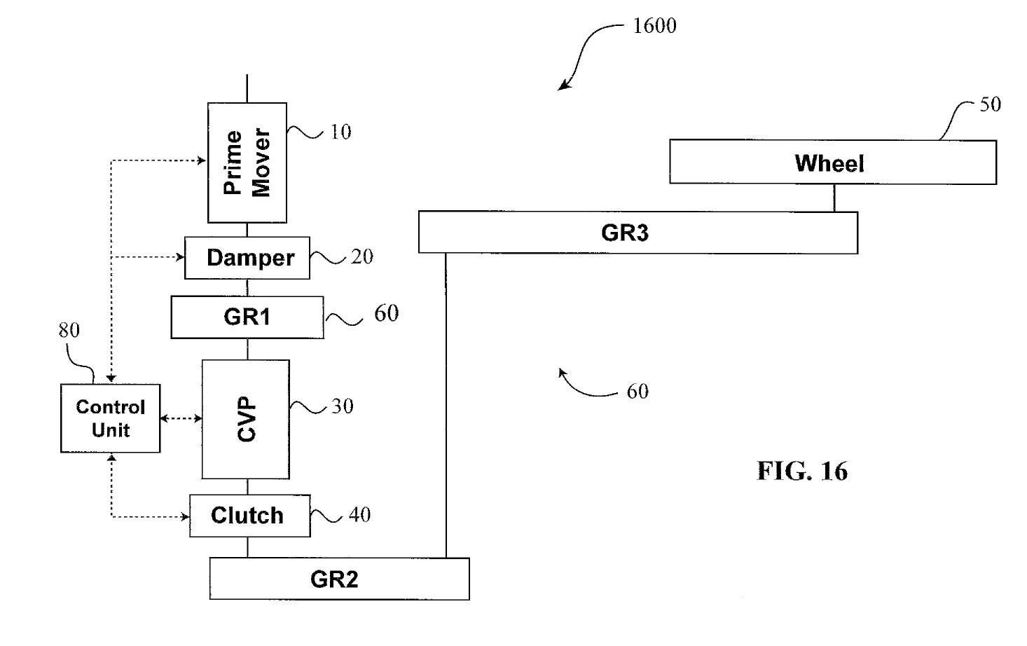

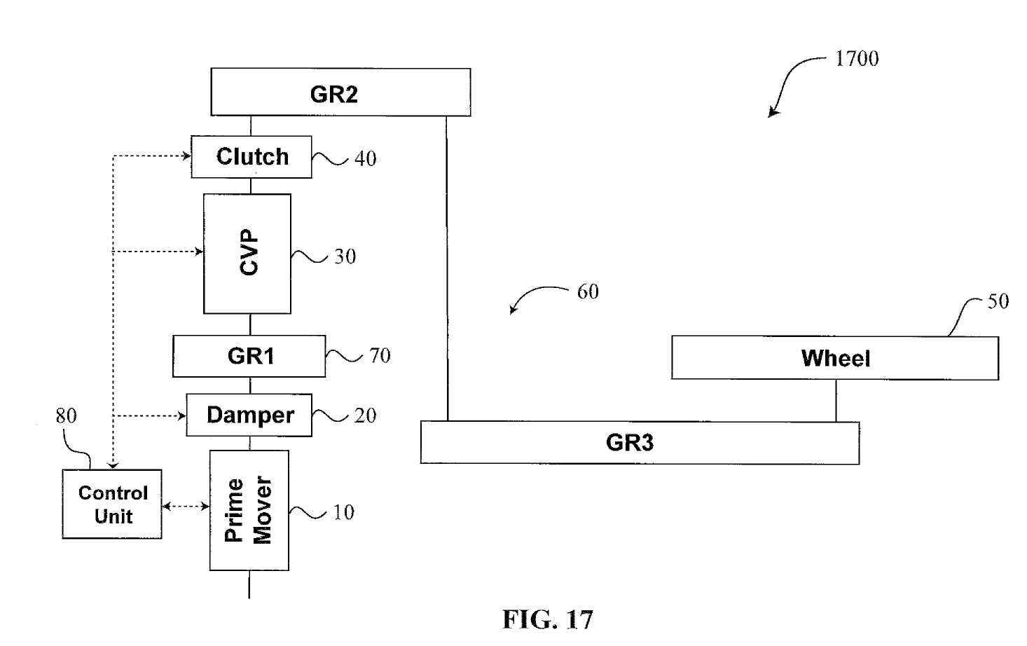

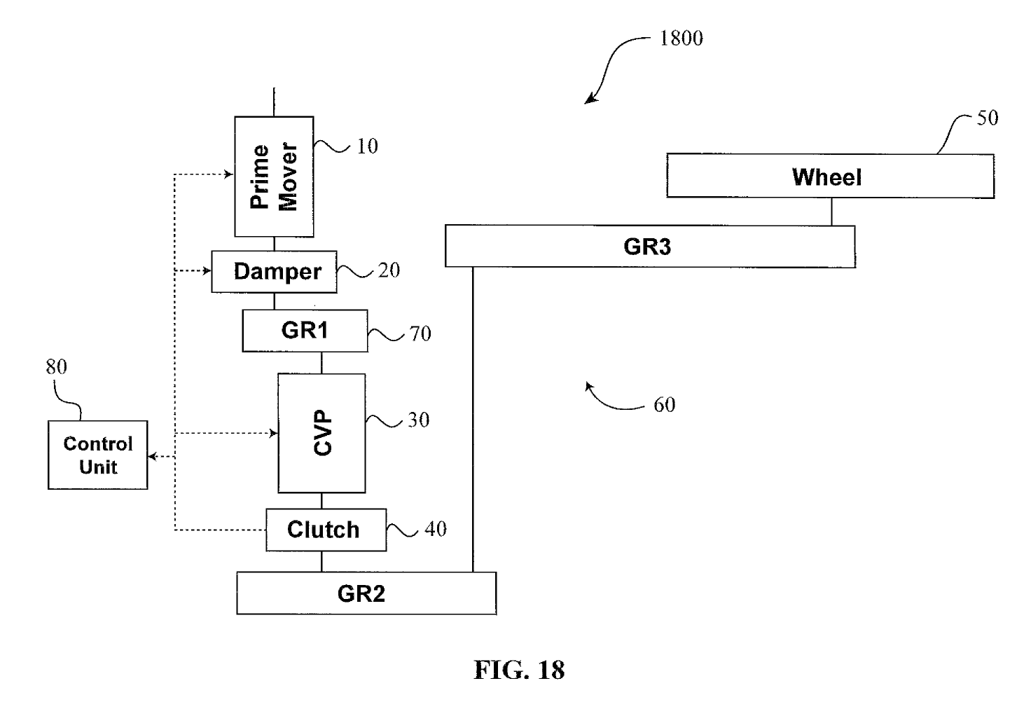

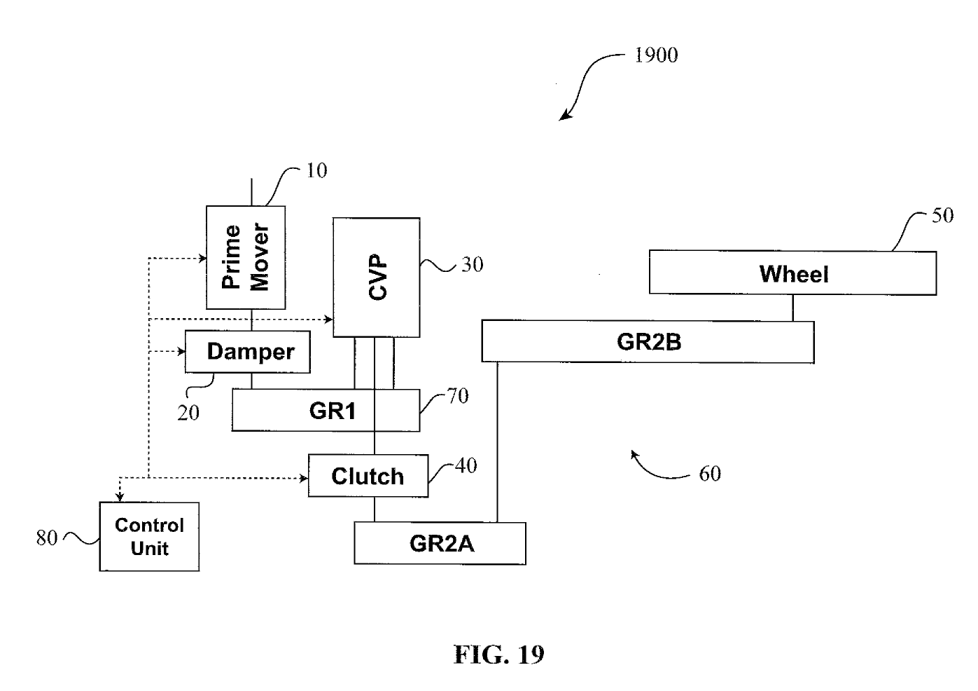

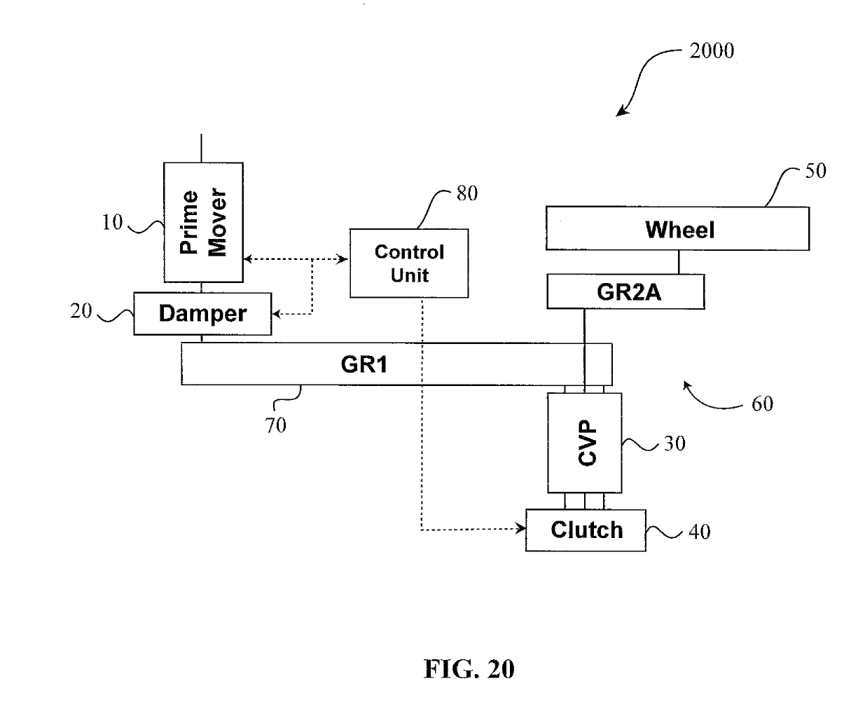

### DETAILED DESCRIPTION OF CERTAIN EMBODIMENTS

Embodiments of the present disclosure will now be described with reference to the accompanying figures, wherein like numerals refer to like elements throughout. The terminology used in the description presented herein is not intended to be interpreted in any limited or restrictive manner simply because it is being utilized in conjunction with a detailed description of certain specific embodiments of the present disclosure. Furthermore, embodiments of the present disclosure may include several novel features, no single one of which is solely responsible for its desirable attributes or which is essential to practicing the present disclosure herein described.

Embodiments disclosed herein relate generally to continuously variable transmissions (CVTs), including infinitely variable transmissions (IVTs). More particularly, embodiments relate to CVTs and their components, as well as subassemblies and systems which may take advantage of the features, available power paths, and configurations possible with a CVT. Embodiments may also relate to vehicles, equipment, machinery, and other applications which may incorporate the functionality of a CVT to improve the performance or efficiency of existing and known technologies.

For embodiments disclosed with respect to the figures, the following descriptions may be helpful.

As used here, the terms “coupled”, “operationally connected,” “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using these terms to describe certain embodiments of the present disclosure, specific structures or mechanisms that link or couple the elements are typically described. However, unless otherwise specifically stated, when one of these terms is used, the terms indicate that the actual linkage or coupling may take a variety of forms, which in certain instances will be obvious to a person of ordinary skill in the technology. For description purposes, the term “radial” is used here to indicate a direction or position that is perpendicular relative to a longitudinal axis of a transmission or continuous variator. The term “axial” as used here refers to a direction or position along an axis that is parallel to a main or longitudinal axis of a transmission or continuous variator.

Unless otherwise explicitly stated, as used herein, the term “or” refers to an inclusive statement. In other words, the statement “A or B” is true if any of the following conditions are met: A is True and B is False; A is False and B is True; or A is True and B is True.

Certain embodiments of the present disclosure described below incorporate spherical-type variators that use spherical speed adjusters, each of which typically has a tiltable axis of rotation. The speed adjusters are also known as power adjusters, balls, planets, spheres, sphere gears, or rollers. Usually, the adjusters are arrayed radially in a plane perpendicular to a longitudinal axis of a CVT. Traction rings are positioned on each side of the array of planets, with each traction ring being in contact with the planets. Either of the traction rings may apply a clamping contact force to the planets for transmission of torque from a traction ring, through the planets, to the other traction ring. A first traction ring applies input torque at an input rotational speed to the planets. As the planets rotate about their own axes, the planets transmit the torque to a second traction ring at an output rotational speed. The ratio of input rotational speed to output rotational speed (“speed ratio”) is a function of the ratio of the radii of the contact points of the first and second traction rings, respectively, to the rotational axes of the planets. Tilting the axes of the planets with respect to the axis of the CVT adjusts the speed ratio.

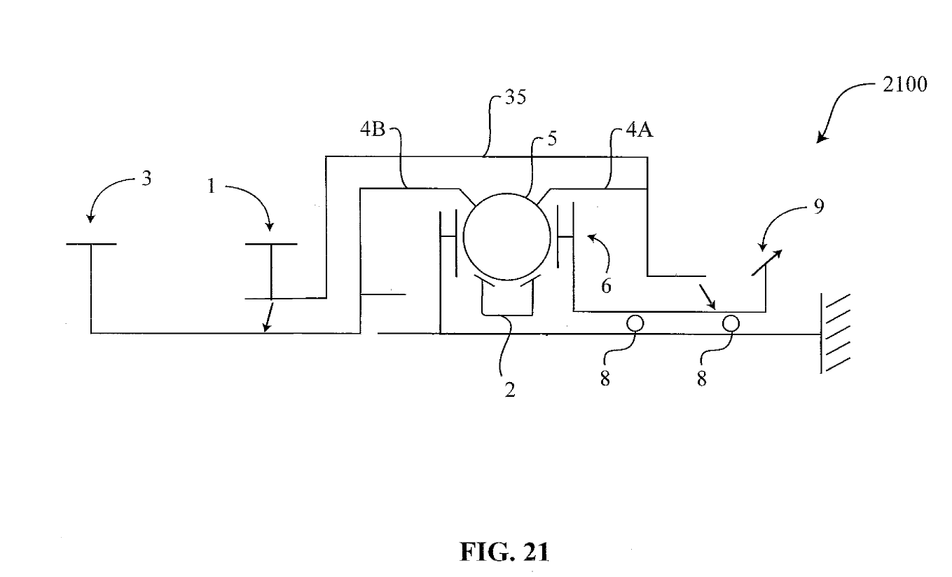

FIGS. 21-24 depict schematic diagrams of ball-planetary continuously variable transmissions (CVP's), illustrating configurations in which a CVP may be used as a U-drive or a through-drive transmission according to the present disclosure. Power may enter any of CVPs 2100, 2200, 2300, or 2400 via input sprocket 1 and be transferred through first traction ring 4A, planets 5, out second traction ring 4B to output sprocket 3. Sun 2 may be positioned radially inward of planets 5. Carrier 6 may be used to adjust a tilt angle of planets 5. Seals 8 may ensure a traction fluid is maintained within a CVP. Actuator 9 may control carrier 6 or otherwise tilt planets 5 to provide a target speed ratio.

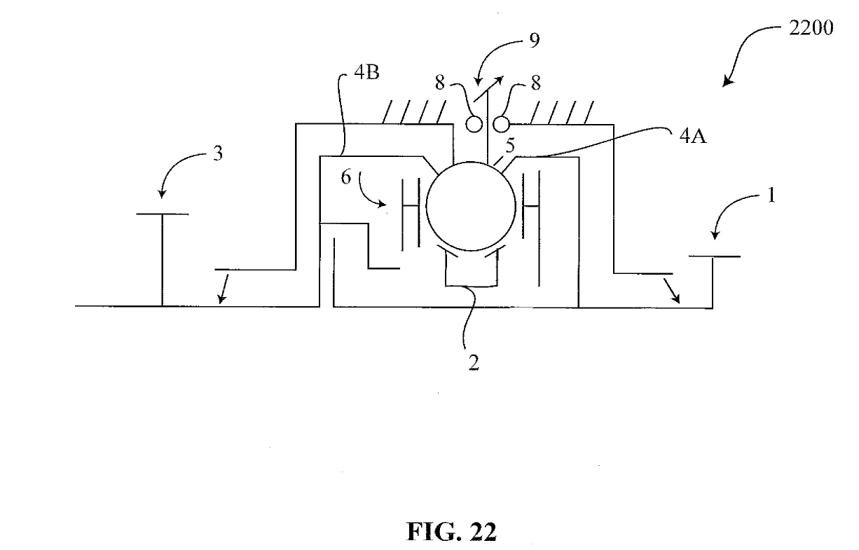

As depicted in FIGS. 21 and 22, CVP 2100 and 2200 may function as a through-drive (i.e., input sprocket 1 and output sprocket 3 are located on opposite sides of planets 5).

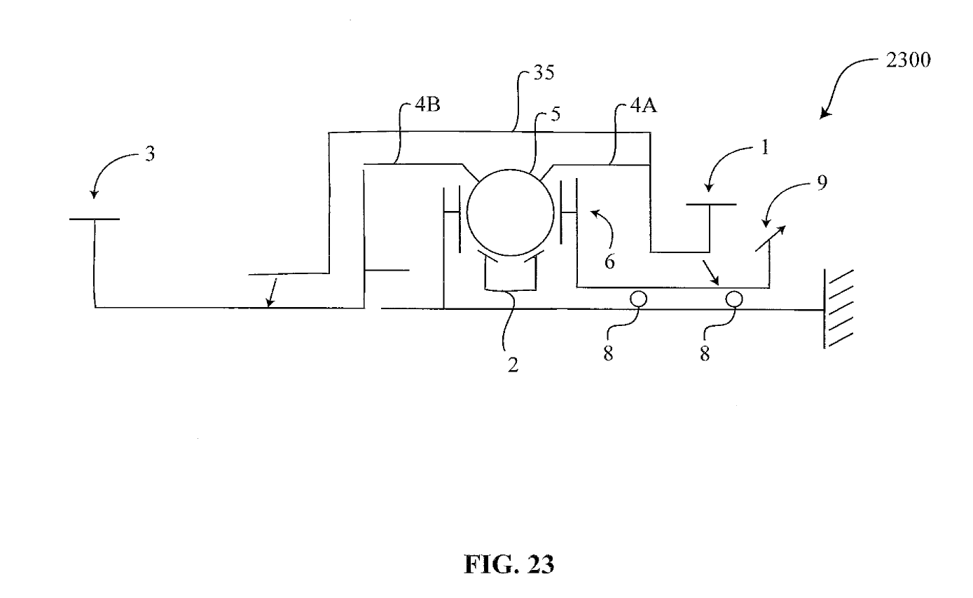

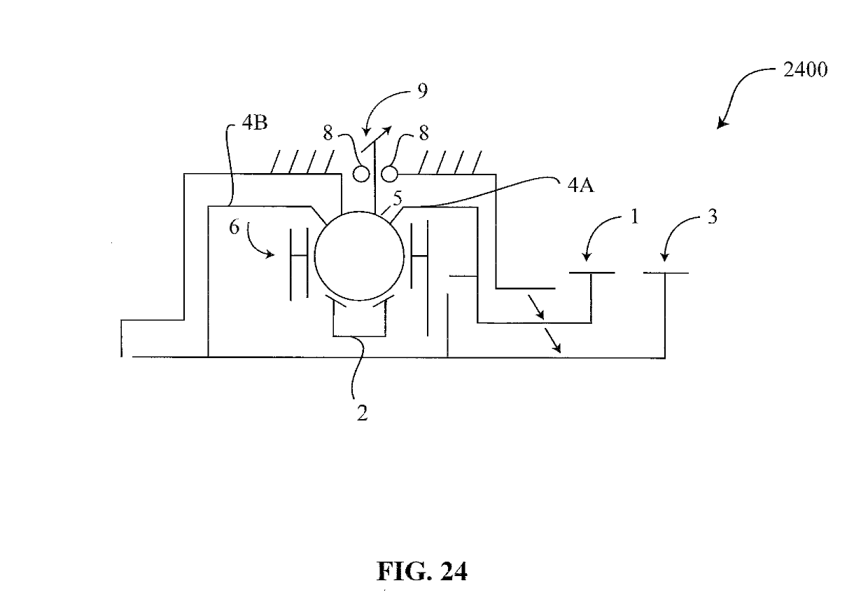

As depicted in FIGS. 23 and 24, CVP 2300 and 2400 may function as a U-drive (i.e., input sprocket 1 and output sprocket 3 are located on the same side of planets 5).

One aspect of the torque/speed regulating devices disclosed here relates to drive systems for industrial vehicles which may operate at various speeds and require varying amounts of torque. A motorcycle is one example of a vehicle that might move at varying speeds and torques, depending on the terrain, the weight of the rider, and other factors. A prime mover in a motorcycle can be, for example, an electrical motor and/or an internal combustion engine. A motorcycle may also run other devices off the motor, including an alternator and a pump. Usually, the speed of a prime mover varies as the speed or power requirements change. The alternator or pump may operate optimally at another speed.

In the configurations presented herein, a ball-planetary type continuously variable transmission may be enclosed in a hub shell. In some embodiments, a CVP is enclosed in a hub shell that is rotatable (also referred to as a spinning hub shell). Ball-planetary type continuously variable transmissions (CVPs) can experience windage due to the presence of traction fluid around the planets. The effects of windage vary according to the type of traction fluid and the volume of traction fluid, as well as the geometry of the CVT. Loss of efficiency and reduced power capacity are significant concerns, but so are foaming, excessive turbulence, CVT damage, decreased service life and fluid damage are some examples of effects that may be the result of excessive windage.

In some embodiments, air cooling may be sufficient to cool all components in a scooter or motorcycle. In other embodiments, due to the size of the prime mover or other component, the position or orientation of any one component, the arrangement or configuration of any group of components, or the aerodynamic shielding or routing of air flow by a component or group of components, air cooling might be insufficient and additional cooling techniques may be necessary or target. A lubrication system may circulate lubricant adapted to coat and/or cool various components of a drivetrain. Embodiments disclosed herein include a lubrication system capable of supplying lubrication to key components while reducing the effects of windage.

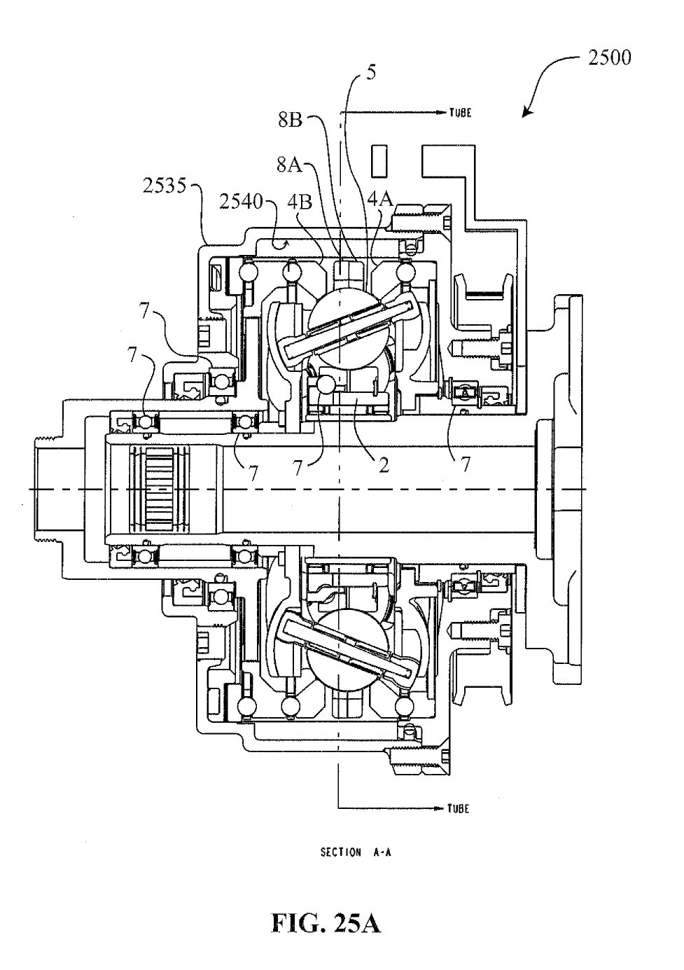

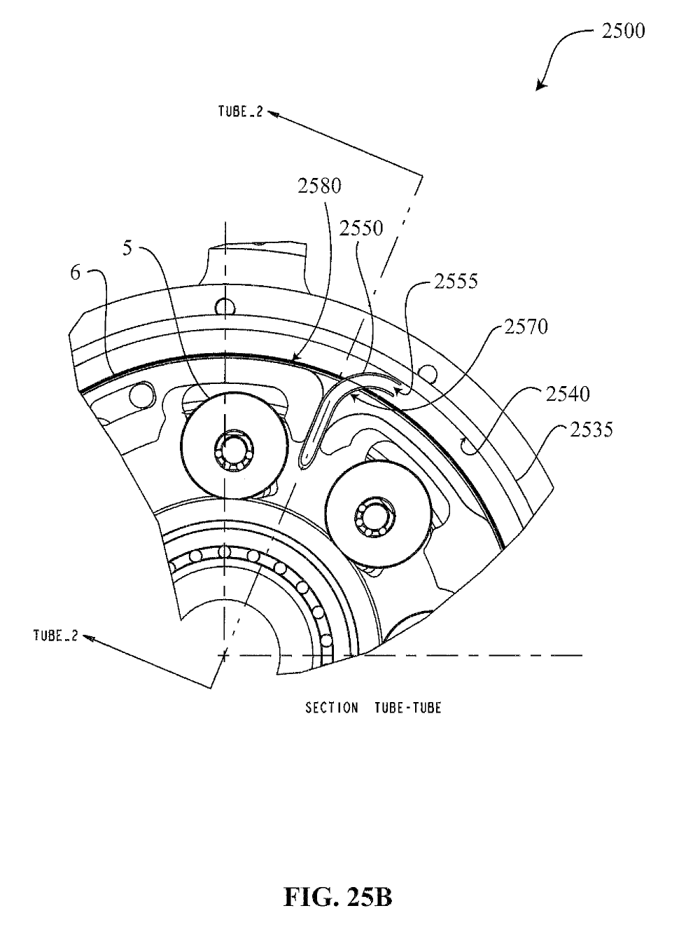

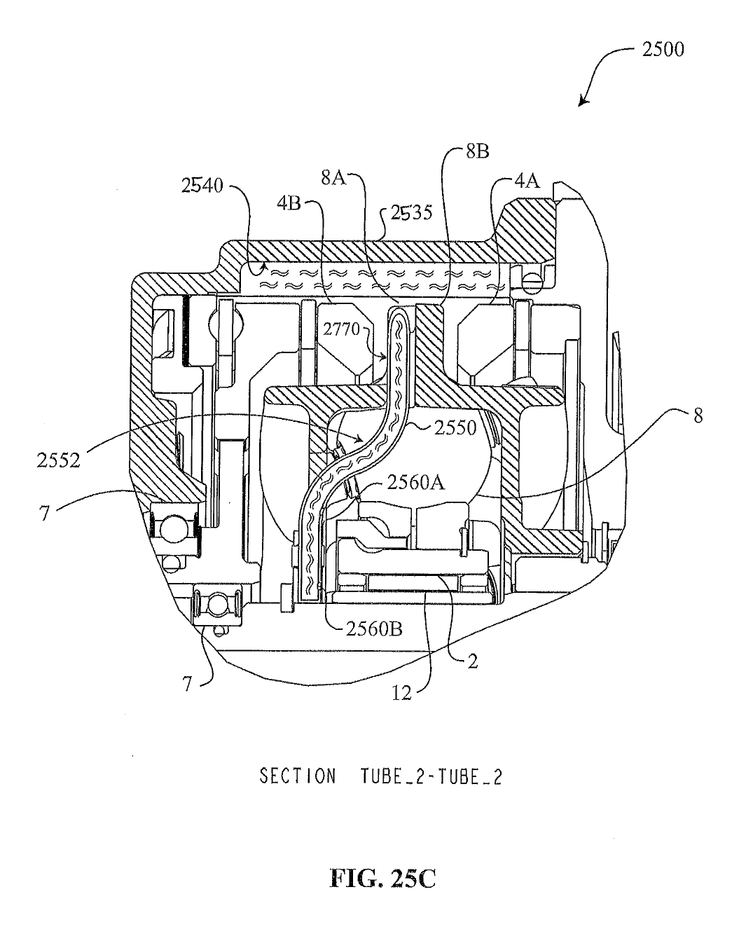

FIG. 25A depicts a cutaway view of one embodiment of a ball planetary continuously variable transmission (CVP) having a spinning hub shell 2535, with traction fluid circulating and in contact with inner surface 2540 of hub shell 2535. In some embodiments, traction fluid may circulate between inner surface 2540 of hub shell 2535 and radially outward of traction rings 4A, 4B, outer surface 2580 of carrier 8A, 8B, radially outward of spherical planets 5, or some other component, depending on target operating parameters of CVP 2500.

FIGS. 25B-25C depict partial cutaway views of a portion of one embodiment of a continuously variable transmission, illustrating an exemplary lubrication system and a fluid circulation pattern relative to components in a spinning hub shell.

As hub shell 2535 of CVP 2500 rotates, fluid generally migrates radially outward in hub shell 2535 and circulates toward interior surface 2540 due to centrifugal action. Fluid in contact with interior surface 2540 will start circulating in the same direction that hub shell 2535 rotates. The velocity at which fluid flows depends on surface features and other characteristics of interior surface 2540, surface friction between interior surface 2540 and molecules of the fluid, viscosity and other characteristics of the fluid, and other characteristics of the CVT. In some embodiments, interior surface 2540 is a continuous surface, whereby surface friction between interior surface 2540 and the fluid is the predominant mechanism by which fluid flows. In other embodiments, interior surface is discontinuous, and grooves (transverse or longitudinal), dimples or other recessed or protruding features may push fluid or otherwise generate fluid flow forces to cause fluid to flow, or may increase a surface area of interior surface 2540 or otherwise adhere the fluid to interior surface 2540, thereby increasing the volume of fluid available for use in a speed-based lubrication system.

FIGS. 25B-25C further depict partial cutaway side views of embodiments of a speed-based lubrication system. As depicted in FIGS. 25B-25C, a speed-based lubrication system may include tube 2550 positioned in CVP 2500 with orifice 2555 extending radially outward into fluid that is centrifugally held out at interior surface 2540 and openings 2560A, 2560B located radially inward to direct the fluid to a sun pilot bearing or other components of CVP 2500. In some embodiments, tube 2550 may include middle portion 2552 having one or more curves, angles, orifices, nozzles or other fluid dynamics feature. The size or shape of any fluid dynamics feature may ensure a flow rate of a lubrication fluid exiting openings 2560A, 2560B is at least a minimum flow rate, less than a maximum flow rate, or within some range of flow rates, or may ensure a fluid pressure of a lubrication fluid exiting openings 2560A, 2560B is at least a minimum fluid pressure, less than a maximum fluid pressure, or within some range of fluid pressures.

Orifice 2555 is ideally situated near interior surface 2540 such that tube 2550 interacts with fluid. As the fluid interacts with tube 2550, a volume of the fluid will enter orifice 2555 of tube 2550 near interior surface 2540 of hub shell 2535 and flow through tube 2550 to one or more openings 2560 located radially inward. The viscosity and other characteristics of the fluid, the rotational velocity of the shell, and the orifice and tube internal characteristics determine the pressure and rate at which fluid flows through tube 2550 to openings 2560. Openings 2560 are arranged and configured to provide a flow rate of fluid at a target pressure to be delivered to one or more components. In some embodiments, orifice 2555 may be configured to provide an input flow rate and pressure and two or more openings 2560A, 2560B may allow equal or controlled flow rates and pressures of traction fluid.

The fluid volume may be selected so that the planets are partially submerged in a fluid region. The level to which the planets are submerged may be based on maximizing fluid delivered to a component (such as a sun, ring, or other component of CVP 2500), maximizing fluid passing through an orifice, minimizing windage, or some other performance characteristic.

Fluid in contact with the planets will adhere to the planets until the spin reaches a speed to cast or sling the fluid outward and radially towards the drive center (sun assembly).

As depicted in FIGS. 25A-25C, tube 2550 in a lubrication system may receive fluid from a fluid volume circulating radially outward in hub shell 2535 (such as fluid that is centrifugally held out at hub shell 2535 interior surface 2540) and direct the fluid to a target area or component within CVP 2500. Fluid may be received via orifice 2555 oriented circumferentially, may circulate in tube 2550 radially inward due to fluid pressure applied by the fluid at orifice 2555, and may exit tube 2550 axially through one or more openings 2560A, 2560B. The positioning and/or orientation of openings 2560 2560A, 2560B may be to provide fluid to a particular region or component. In some embodiments, at least one opening 2560 is positioned, shaped or configured to provide fluid to a sun pilot bearing associated with sun 2.

At slower speeds, fluid may flow along outer surface 2570 of tube 2550. However, once the rotational speed of hub shell 2535 exceeds a threshold, the effectiveness of using outer surface 2570 for fluid flow may decrease. At these higher speeds, inertia of the fluid may force fluid into orifice 2555 and through tube 2550 to opening 25602560A, 2560B. Tube 2550 may have curves 2552 for directing fluid flow. At slower speeds, fluid may flow along outer surface 2570 of tube 2550 until the fluid reaches curve 2552. At curve 2552, fluid may separate from outer surface 2570.

In some embodiments, orifice 2555 is manufactured with a circular cross section area to be perpendicular to a fluid flow profile of the fluid to maximize flow rate per inlet area. However, in some embodiments orifice 2555 may be manufactured to be angled with respect to the fluid flow profile. Having an asymmetric inlet area or having an angled orifice may be useful for reducing negative effects of windage or ensuring a target flow rate or fluid pressure of lubrication fluid.

In some embodiments, a trough or other circumferential fluid channel is provided in hub shell 2535 to reduce the effects of windage on traction planets while still providing sufficient fluid for cooling. Positioning orifice 2555 of tube 2550 in a trough may allow orifice 2555 to be made smaller without the associated drag coefficient. In some embodiments, if orifice 2555 is positioned in a trough, orifice 2555 may be manufactured with a tear drop, angled, triangular, or other cross section area complementary to a cross section area of the trough.

In some embodiments, the oil volume held at interior surface 2540 may be used to act upon a movable carrier to assist with adjusting a speed ratio of CVP 2500. In general, a circulation direction and which carrier 8A, 8B is allowed to tilt planets 5 tends to add torque towards underdrive (UD). Embodiments disclosed herein may include a set of vanes or other features configured to provide direction circulation and formed as part of a fixed carrier that would redirect the fluid in the opposite direction upon a movable carrier to help create torque towards over drive (OD).

In some embodiments, cantilevered links are rotatably pinned to a fixed carrier. One end of the link extends radially outward into fluid retained against interior surface 2540 by inertia (which may be referred to as “centrifugal action”), and the other end of the link extends radially inward and contacts a movable carrier (such as carrier 8A, 8B in FIGS. 21-25C). The shape of the link causes the link to retract or fold out of the fluid stream when a CVP is operating in underdrive (UD) and extend out into stream when the CVP is operating in overdrive (OD). As hub shell 2535 rotates, fluid circulating inside hub shell 2535 contacts a radially outward end of a link causing the link to rotate about its axis. Rotation of the link about its axis causes a radially inward end of the link to contact a movable carrier, biasing the movable carrier toward either underdrive (UD) or overdrive (OD). In one embodiment, the movable carrier is biased toward overdrive.

The embodiments described herein are examples provided to, among other things, meet legal requirements. These examples are only embodiments that may be used and are not intended to be limiting in any manner. Therefore, the claims that follow, rather than the examples, define the present disclosure.

We claim:

1. A ball planetary continuously variable transmission (CVP) having a rotatable hub shell containing a plurality of spherical planets arranged around a main axle defining a longitudinal axis of rotation, each spherical planet having a planet axle defining a planet axis of rotation, wherein tilting the planet axes of rotation changes a speed ratio of the CVP, the rotatable hub shell configured to retain a lubrication fluid, the CVP comprising a lubrication system, the lubrication system comprising:
a lubrication tube configured to supply lubrication to components radially inward of the lubrication tube, the lubrication tube comprising:
a first end extending radially outward;
an orifice at the first end;
a second end extending radially inward; and
an opening at the second end, wherein rotation of the hub shell causes the lubrication fluid to enter the orifice, flow along the tube, and exit the opening.

2. The CVP of claim 1, wherein the hub shell comprises an interior surface, and wherein the first end of the tube extends to a location radially outward of the longitudinal axis and proximate to the interior surface.

3. The CVP of claim 2, wherein the interior surface of the hub shell comprises a smooth surface.

4. The CVP of claim 2, wherein the interior surface of the hub shell comprises a feature for controlling fluid flow of the lubrication fluid.

5. The CVP of claim 2, wherein an exterior surface of a cross-section of the orifice is complementary to a profile of the interior surface.

6. The CVP of claim 1, wherein an exterior surface of a cross-section of the orifice is one of circular, tear drop, angled, or asymmetric.

7. The CVP of claim 4, wherein the feature for controlling fluid flow comprises a circumferential groove, and wherein lubrication fluid is configured to flow into the circumferential groove.

8. The CVP of claim 7, wherein an exterior surface of a cross-section of the orifice is complementary to the circumferential groove.

9. The CVP of claim 1, wherein the opening and a component of the CVP are located at a same location radially outward of the longitudinal axis and proximate to the interior surface.

10. The CVP of claim 9, wherein the component of the CVP comprises a spherical planet.

11. The CVP of claim 1, wherein an outer surface of the tube is configured for contact with the lubrication fluid, whereby lubrication fluid flows radially inward along the outer surface of the tube.

12. The CVP of claim 1, wherein the tube is fixed to a non-rotatable component of the CVP.

13. The CVP of claim 1, wherein the tube is coupled to a carrier of the CVP.
